(19) United States
(12) Patent Application Publication
(10) Pub. No.: US 2026/0360641 A1
(43) Pub. Date: Nov. 12, 2026

(54) VACUUM INTERRUPTER

(71) Applicant: ABB Schweiz AG, Baden (CH)

(72) Inventors: Dietmar Gentsch, Ratingen (DE); Kai Gorlt, Ratingen (DE)

(73) Assignee: ABB Schweiz AG, Baden (CH)

(21) Appl. No.: 19/671,481

(22) Filed: May 8, 2026

(30) Foreign Application Priority Data
May 8, 2025 (EP) 25175128.5

(51) Int. Cl. H01H 33/662; H01H 33/24; H01H 33/664

(52) U.S. Cl. CPC H01H 33/66261; H01H 33/24; H01H 33/664; H01H 2033/66269; H01H 2033/66276; H01H 2033/66292

(57) ABSTRACT

A vacuum interrupter includes first and second contacts, a middle shield, first and second contact end caps, a ceramic housing, and a ceramic ring. The first contact and the first contact end cap are held at a first potential. The second contact and the second contact end cap are held at a second potential. The middle shield is held at a floating potential and located around a region between the first and second contacts. The ceramic housing is located between the first contact end cap and the second contact end cap. The ceramic ring comprises at least one capacitive structure. The ceramic ring is located between the middle shield and the first contact end cap and/or the second contact end cap.

### CROSS-REFERENCE TO RELATED APPLICATIONS

The instant application claims priority to European Patent Application No. 25175128.5, filed May 8, 2025, which is incorporated herein in its entirety by reference.

### FIELD OF THE DISCLOSURE

The present disclosure generally relates to vacuum interrupters.

### BACKGROUND OF THE INVENTION

Vacuum Interrupter Overview- A vacuum interrupter is a component in medium-voltage circuit-breakers, generator circuit-breakers, and high-voltage circuit-breakers. A vacuum interrupter includes electrical contacts placed within a vacuum environment to interrupt the current flow when an arc occurs between the contacts. Vacuum interrupters are widely used in utility power transmission systems, power generation units, railways, arc furnace applications, and industrial plants. Unlike other arc-suppression mediums (such as air, SF6, or oil), vacuum interrupters contain the arc within the interrupter itself.

Since the arc is contained within the vacuum interrupter, switchgear using vacuum interrupters are very compact compared to those using air, SF6, or oil as arc-suppression mediums.

Importance of Voltage Distribution:

Insulation Strength: The voltage distribution directly impacts the insulation strength of the vacuum interrupter both internally and externally, as well as the voltage potential on floating elements like shielding. Ideally, these should maintain a well-distributed voltage potential along the vacuum interrupter to ensure high performance. Even when an earthed element is placed close to the vacuum interrupter, it is known that capacitive coupling effects can shift floating potentials and reduce the withstand voltage. When high voltage is applied, the electric field strength between the contacts and shielding must be uniform to prevent breakdown.

Arc Extinction: When the electrical contacts separate, a metal vapor arc forms. The vacuum interrupter’s design ensures that this arc is quickly extinguished.

Metal Vapor Arc Control: The voltage distribution influences the shape of the electric field inside the interrupter. A well-controlled electric field contributes to a higher open-circuit voltage rating.

Energy Absorption: The vacuum interrupter’s shield absorbs some of the energy produced during the arc, increasing the device’s interrupting rating.

In summary, maintaining a homogeneous potential along the vacuum interrupter, especially considering the outer side and gas atmosphere, is crucial for reliable insulation, efficient current interruption, and the ability to withstand high voltages. However, this is not always easy to achieve.

### BRIEF SUMMARY OF THE INVENTION

The present disclosure generally describes an improved vacuum interrupter. In one aspect, the present disclosure describes a vacuum interrupter that includes: a first contact; a second contact; a middle shield; a first contact end cap; a second contact end cap; a ceramic housing; and at least one ceramic ring or segment.

The first contact is configured to be held at a first potential when the first contact and the second contact are separated from one another. The second contact is configured to be held at a second potential when the first contact and the second contact are separated from one another. The first contact end cap is configured to be held at the first potential when the first contact and the second contact are separated from one another. The second contact end cap is configured to be held at the second potential when the first contact and the second contact are separated from one another. The middle shield is configured to be held at floating potential. The middle shield is located around a region between the first contact and the second contact. The ceramic housing is located between the first contact end cap and the second contact end cap. Each of the at least one ceramic ring or segment comprises at least one capacitive structure. One or more ceramic rings or segments of the at least one ceramic ring or segment is located between the middle shield and the first contact end cap and/or wherein one or more ceramic rings or segments of the at least one ceramic ring or segment is located between the middle shield and the second contact end cap.

### BRIEF DESCRIPTION OF THE SEVERAL VIEWS OF THE DRAWING(S)

Exemplary embodiments will be described in the following with reference to the following drawings:

FIG. 1a shows a cross section through a standard vacuum interrupter, showing one half of the vacuum interrupter;

FIG. 1b shows the potential distribution around the vacuum interrupter of FIG. 1a;

FIG. 2. shows a cross section through a new vacuum interrupter, showing one half of the vacuum interrupter;

FIG. 3. shows a cross section through a new vacuum interrupter, showing one half of the vacuum interrupter;

FIG. 4. shows a cross section through a new vacuum interrupter, showing one half of the vacuum interrupter;

FIG. 5. shows a cross section through a new vacuum interrupter, showing one half of the vacuum interrupter;

FIG. 6. shows a cross section through a new vacuum interrupter, showing one half of the vacuum interrupter;

FIG. 7. shows the potential distribution around the vacuum interrupter of FIG. 4;

FIG. 8 and 9. show the potential distribution around the vacuum interrupter of FIG. 4 where an earthed plate has been placed 100mm from the vacuum interrupter;

FIG. 10 shows a cross section through a new vacuum interrupter, showing one half of the vacuum interrupter, showing how the new development can be applied to a double vacuum interrupter;

FIG. 11 and 12. show the potential distribution around the vacuum interrupter of FIG. 10 where an earthed plate has been placed 100mm from the vacuum interrupter.

### DETAILED DESCRIPTION OF THE INVENTION

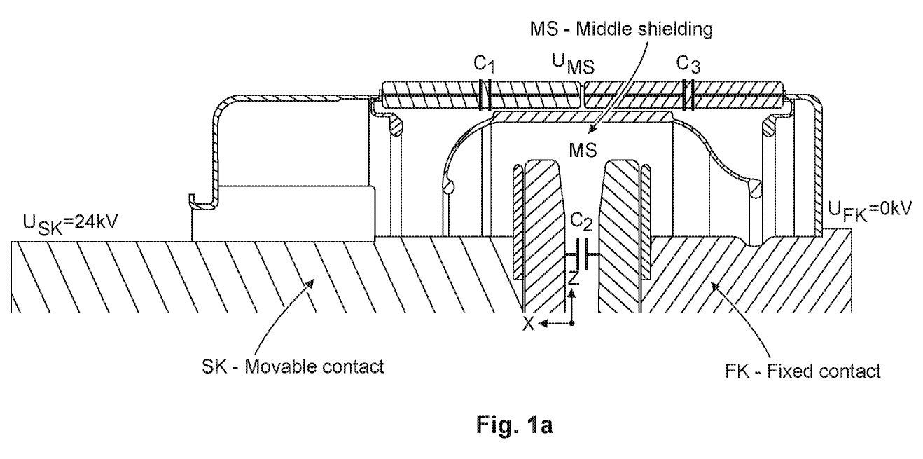

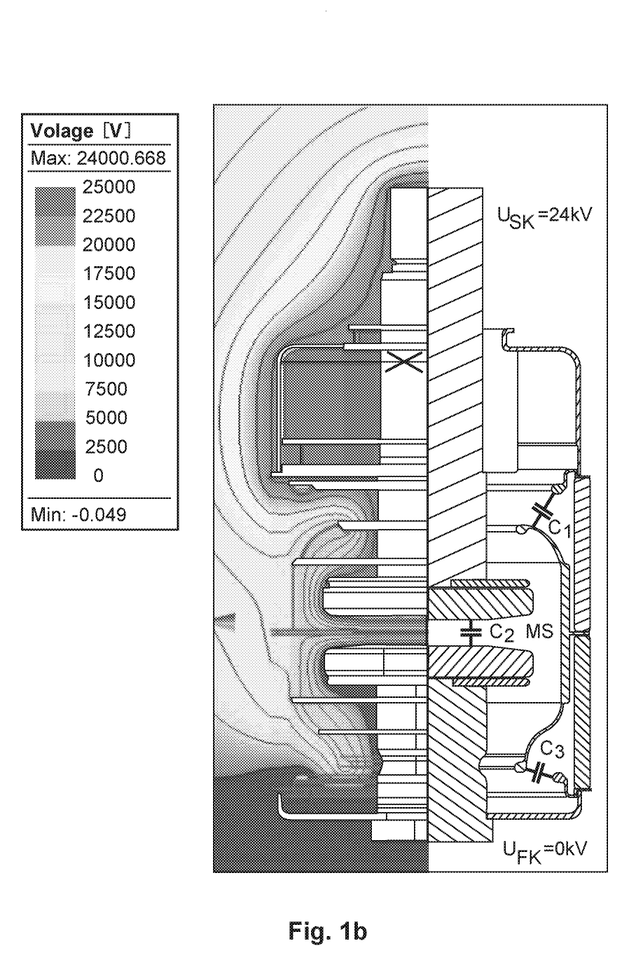

FIGS. 1a and 1b relate to a standard vacuum interrupter. A movable contact SK, which is at 24kV as an example voltage, is spaced from a fixed contact FK, which is at 0 kV. A middle shield or shielding MS is located around the region where the two contacts are spaced from one another, which is at floating potential. A first contact end cap at least partially surrounds the movable contact, and the movable contact can move with respect to the first contact end cap. The first contact end cap is held at the potential of the movable contact. A second contact end cap at least partially surrounds the fixed contact can be attached to the fixed contact. The first contact end cap is held at the potential of the fixed contact. A ceramic housing is located between the first contact end cap and the second contact end cap and is formed from two parts. A first part is located between the first contact end cap and the midpoint of the middle shield, and a characteristic capacitance C1 is associated with the first part. A second part is located between the second contact end cap and the midpoint of the middle shield, and a characteristic capacitance C3 is associated with the first part. A characteristic capacitance C2 is associated with the two contacts, that in effect form a parallel plate capacitor.

In an ideal situation, the voltage distribution along the vacuum interrupter USK/MS/UFK/MS should be 50%/50%. In a free-standing case, the voltage distribution along the vacuum interrupter, in FIG. 1a/1b that is in isolation, USK/MS/UFK/MS is 52%/48%. To mimic reality, a case when a 100mm earthing plate is located 100mm from the ceramic surface leads to a voltage distribution along the vacuum interrupter, in FIG. 1a/1b, USK/MS/UFK/MS of 56%/44%.

In one embodiment, an example of a vacuum interrupter comprises: a first contact; a second contact; a middle shield; a first contact end cap; a second contact end cap; a ceramic housing; and at least one ceramic ring or segment.

The first contact is configured to be held at a first potential when the first contact and the second contact are separated from one another. The second contact is configured to be held at a second potential when the first contact and the second contact are separated from one another. The first contact end cap is configured to be held at the first potential when the first contact and the second contact are separated from one another. The second contact end cap is configured to be held at the second potential when the first contact and the second contact are separated from one another. The middle shield is configured to be held at floating potential. The middle shield is located around a region between the first contact and the second contact. The ceramic housing is located between the first contact end cap and the second contact end cap. Each of the at least one ceramic ring or segment comprises at least one capacitive structure. One or more ceramic rings or segments of the at least one ceramic ring or segment is located between the middle shield and the first contact end cap and/or wherein one or more ceramic rings or segments of the at least one ceramic ring or segment is located between the middle shield and the second contact end cap.

It is to be noted that it´s not needed that the middle shield or the shielding are fixed on the outer ceramic, there exist the opportunity to fix them all due to the inner capacitor rings or segments and keeping them on fixe distance and holding the inner shield structure from movable side to fixed contact side in position. It is to be noted that reference to a middle shield can mean that there is a single middle shield element or that the middle shield is formed as a multi shield arrangement. It is to be noted that a ceramic ring or segment can mean a complete ceramic ring or ceramic segment or part of a ceramic ring or ceramic segment.

In an example, the first contact is a movable contact SK and the second contact is a fixed contact FK.

In an example, a ceramic ring or segment of the one or more ceramic rings or segments located between the middle shield and the first contact end cap is located external to the ceramic housing, and a capacitive structure of the ceramic ring or segment comprises at least one metalized cylindrical surface.

Located external to the ceramic housing means located outside of the ceramic housing, in that the ceramic housing is spaced a first radial distance from a centre axis of the vacuum interrupter and the ceramic ring or segment located external to the ceramic housing is then located such that it is spaced a second radial distance from the centre axis of the vacuum interrupter that is greater than the first radial distance.

In an example, wherein the least one metalized cylindrical surface of the ceramic ring or segment located external to the ceramic housing comprises an inward facing surface.

In an example, the inward facing surface is within a groove in the ceramic ring or segment.

In an example, the at least one metalized cylindrical surface of the ceramic ring or segment located external to the ceramic housing comprises an outward facing surface.

In an example, the outward facing surface is within a groove in the ceramic ring or segment located external to the ceramic housing.

In an example, a first end face of the ceramic ring or segment located external to the ceramic housing is metalized and electrically connected to the middle shield and a second end face of the ceramic ring or segment located external to the ceramic housing opposite to the first end face is metalized and electrically connected to the first contact end cap.

In an example, a capacitive structure is formed between the at least one metalized cylindrical surface of the ceramic ring or segment located external to the ceramic housing and the first end face of the ceramic ring or segment located external to the ceramic housing.

In an example, a capacitive structure is formed between the at least one metalized cylindrical surface of the ceramic ring or segment located external to the ceramic housing and the second end face of the ceramic ring or segment located external to the ceramic housing.

In an example, a capacitive structure comprises at least one further metalized cylindrical surface of the ceramic ring or segment located external to the ceramic housing.

In an example, the least one further metalized cylindrical surface of the ceramic ring or segment located external to the ceramic housing comprises an inward facing surface.

In an example, the inward facing surface is within a further groove in the ceramic ring or segment located external to the ceramic housing.

In an example, the at least one further metalized cylindrical surface of the ceramic ring or segment located external to the ceramic housing comprises an outward facing surface.

In an example, the outward facing surface is within a further groove in the ceramic ring or segment located external to the ceramic housing.

In an example, a further capacitive structure is formed between the at least one metalized cylindrical surface of the ceramic ring or segment located external to the ceramic housing and the at least one further metalized cylindrical surface of the first ceramic ring or segment.

In an example, a capacitive structure is formed between the at least one further metalized cylindrical surface of the ceramic ring or segment located external to the ceramic housing and the second end face of the first ceramic ring or segment.

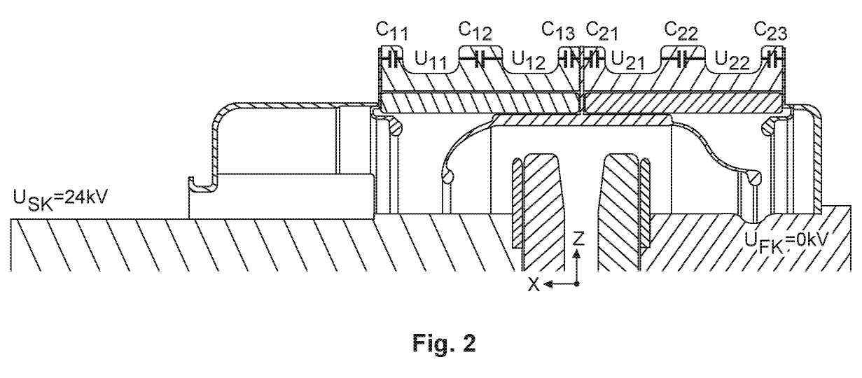

Thus, an externally located ceramic ring or segment located between the middle shield and the first contact end cap acts as one or more capacitors, where one or more capacitors can be formed between a metalized groove in the ceramic ring or segment and a metallized end face of the ceramic ring or segment that is connected to the middle shield, and between metalized grooves themselves, and between a metalized groove in the ceramic ring or segment and a metallized end face of the ceramic ring or segment that is connected to the first contact end cap, as shown in FIG. 2.

In an example, a ceramic ring or segment of the one or more ceramic rings or segments located between the middle shield and the second contact end cap is located external to the ceramic housing, and wherein a capacitive structure of the ceramic ring or segment comprises at least one metalized cylindrical surface.

In an example, the least one metalized cylindrical surface of the ceramic ring or segment located external to the ceramic housing and located between the middle shield and the second contact end cap comprises an inward facing surface.

In an example, the inward facing surface is within a groove in the ceramic ring or segment located external to the ceramic housing and located between the middle shield and the second contact end cap.

In an example, the least one metalized cylindrical surface of the ceramic ring or segment located external to the ceramic housing and located between the middle shield and the second contact end cap comprises an outward facing surface.

In an example, the outward facing surface is within a groove in the ceramic ring or segment located external to the ceramic housing and located between the middle shield and the second contact end cap.

In an example, a first end face of the ceramic ring or segment located external to the ceramic housing and located between the middle shield and the second contact end cap is electrically connected to the middle shield (or shielding’s in case of a multi-shield arrangement) and a second end face of the ceramic ring or segment located external to the ceramic housing and located between the middle shield and the second contact end cap opposite to the first end face is electrically connected to the second contact end cap.

In an example, a capacitive structure is formed between the at least one metalized cylindrical surface of the ceramic ring or segment located external to the ceramic housing and located between the middle shield and the second contact end cap and the first end face of the ceramic ring or segment located external to the ceramic housing and located between the middle shield and the second contact end cap.

In an example, a capacitive structure is formed between the at least one metalized cylindrical surface of the ceramic ring or segment located external to the ceramic housing and located between the middle shield and the second contact end cap and the second end face of the ceramic ring or segment located external to the ceramic housing and located between the middle shield and the second contact end cap. Thus, in case of a multi shield arrangement are in between the selected shield these ceramic rings or segments are located.

In an example, a capacitive structure comprises at least one further metalized cylindrical surface of the ceramic ring or segment located external to the ceramic housing and located between the middle shield (or many of those shields in case of multi shield design in high voltage) and the second contact end cap.

In an example, the least one further metalized cylindrical surface of the ceramic ring or segment located external to the ceramic housing and located between the middle shield (or middle shielding if selected) and the second contact end cap comprises an inward facing surface.

In an example, the inward facing surface is within a further groove in the ceramic ring or segment located external to the ceramic housing and located between the middle shield and the second contact end cap.

In an example, the at least one further metalized cylindrical surface of the ceramic ring or segment located external to the ceramic housing and located between the middle shield and the second contact end cap comprises an outward facing surface.

In an example, the outward facing surface is within a further groove in the ceramic ring or segment located external to the ceramic housing and located between the middle shield and the second contact end cap.

In an example, a further capacitive structure is formed between the at least one metalized cylindrical surface of the ceramic ring or segment located external to the ceramic housing and located between the middle shield and the second contact end cap and the at least one further metalized cylindrical surface of the ceramic ring or segment located external to the ceramic housing and located between the middle shield and the second contact end cap.

In an example, a further capacitive structure is formed between the at least one further metalized cylindrical surface of the ceramic ring or segment located external to the ceramic housing and located between the middle shield and the second contact end cap and the second end face of the ceramic ring or segment located external to the ceramic housing and located between the middle shield (or the shielding if selected) and the second contact end cap. Thus, an externally located ceramic ring or segment located between the middle shield and the second contact end cap acts as one or more capacitors, where one or more capacitors can be formed between a metalized groove in the ceramic ring or segment and a metallized end face of the ceramic ring or segment that is connected to the middle shield, and between metalized grooves themselves, and between a metalized groove in the ceramic ring or segment and a metallized end face of the ceramic ring or segment that is connected to the second contact end cap, as shown in FIG. 2.

Referring to FIG. 2, the ceramic housing is still present but two further ceramic rings or segments have been added that are external to the ceramic housing, one between the first contact end cap and the mid-point of the middle shield and the second between the second contact end cap and the mid-point of the middle shield. It is to be noted, that in effect the intrinsic capacitances C1, C2, and C3, as shown in FIGS. 1a and 1b are still present but additional steering capacitances have been added to provide a more homogeneous voltage distribution. Specifically, areas with capacitances included in the design have been added (Furthermore the separated ceramics can be selected as one part with grooves as well). Each capacitance is incorporated into a separate ceramic embodiment or the ceramic cylinder wall. In the groove areas (U11, U12, U21, U22) of the ceramic cylinder, metallization has been introduced to achieve the capacitance (C11, C12, C13/C21, C22, C23) for steering purposes. In FIG. 2 metallization is shown on the outer surface, but this can also or alternatively be on the inner surface. This can be achieved by using metal (silver) painting lacquer or coating by PVD/CVD technology. The metallization can be done before production of the vacuum interrupter and for the external coating can be done after production.

In an example, a ceramic ring or segment of the one or more ceramic rings or segments located between the middle shield and the first contact end cap is located internal to the ceramic housing, and a capacitive structure of the ceramic ring or segment comprises that a first end face of the first ceramic ring or segment is metalized and electrically connected to the middle shield or on middle shields.

Located internal to the ceramic housing means located inside of the ceramic housing, in that the ceramic housing is spaced the first radial distance from the centre axis of the vacuum interrupter and the ceramic ring or segment located internal to the ceramic housing is then located such that it is spaced a third radial distance from the centre axis of the vacuum interrupter that is less than the first radial distance.

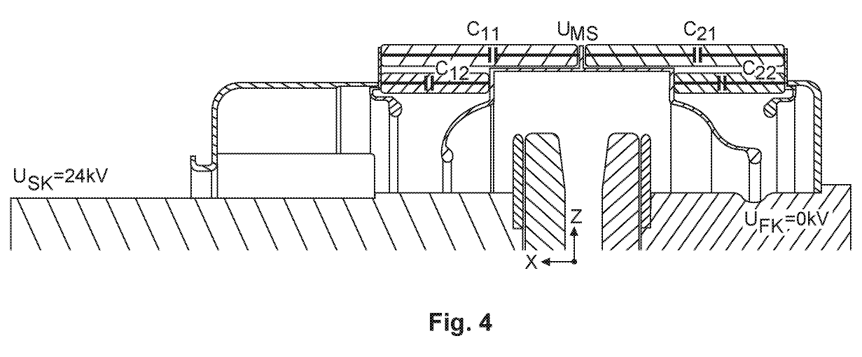

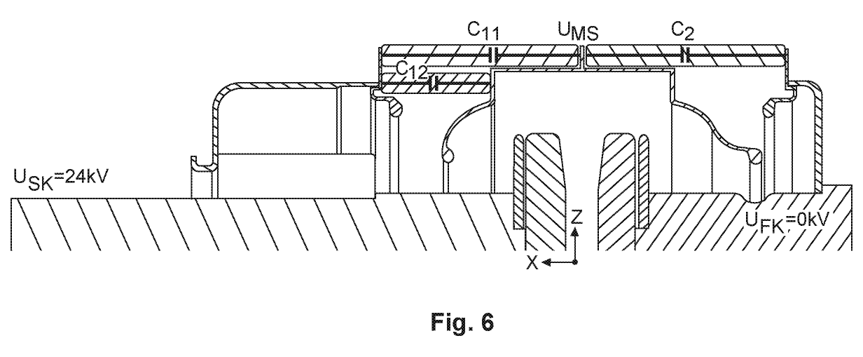

In an example, a capacitive structure of the ceramic ring or segment located internal to the ceramic housing comprises that a second end face of the ceramic ring or segment opposite to the first end face of the ceramic ring or segment is metalized and electrically connected to the first contact end cap. Thus, the internal ceramic ring or segment in effect acts as a parallel plate capacitor with metalized ends, as shown in FIGS. 4 and 6.

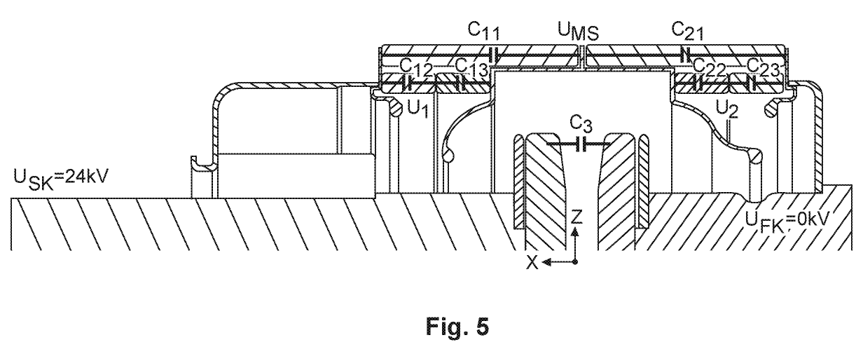

In an example, a further ceramic ring or segment of the one or more ceramic rings or segments located between the middle shield (or in case of multiple shielding between all of them or partly between some) and the first contact end cap is located internal to the ceramic housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the first contact end cap. Thus, the internal ceramic rings or segments in effect act as parallel plate (ring/segment) capacitors in series with metalized ends, as shown in FIG. 5.

In an example, a ceramic ring or segment of the one or more ceramic rings or segments located between the middle shield (or the shielding in case there will be used a multiple shield design) and the second contact end cap is located internal to the ceramic housing, and a capacitive structure of the ceramic ring or segment comprises that a first end face of the ceramic ring or segment is metalized and electrically connected to the middle shield(or the shielding on each the sides for a multi shield design).

In an example, a capacitive structure of the ceramic ring or segment located internal to the ceramic housing and located between the middle shield and the second contact end cap comprises that a second end face of the ceramic ring or segment opposite to the first end face of the ceramic ring or segment is metalized and electrically connected to the second contact end cap. Thus, the internal ceramic ring or segment in effect acts as a parallel plate capacitor with metalized ends, as shown in FIGS. 4 and 6.

In an example, a further ceramic ring or segment of the one or more ceramic rings or segments located between the middle shield and the second contact end cap is located internal to the ceramic housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the second contact end cap. Thus, the internal ceramic rings or segments in effect act as parallel plate capacitors in series with metalized ends, shown in FIG. 5.

Referring to FIG. 4, the ceramic housing is still present but two further ceramic rings or segments have been added that are internal to the ceramic housing, one between the first contact end cap and the middle shield and the second between the second contact end cap and the middle shield. It is to be noted, that in effect the intrinsic capacitances C1, C2, and C3, as shown in FIGS. 1a and 1b are still present, where the intrinsic capacitances associated with the two parts of the ceramic housing are shown as C11, C21 in FIG. 4. But additional steering capacitances have been added to provide a more homogeneous voltage distribution in the form of two internal ceramic rings or segment that have metalized end faces, and associated capacitances of C12 and C22 for the detailed embodiment shown in FIG. 4. Specifically, each capacitance is incorporated as a ceramic ring / or as a segment “ring”, positioned between the floating shield and one potential to purposefully steer the middle potential. The ceramic ring or segment can be placed as needed, with the option to use none, one, or two rings or segments and in case of a multi-shield design there are some ceramic rings used. Additionally, different capacitances can be installed to adjust the steering at the middle potential, depending on the thickness of the capacitance or the shape of the inner capacitance cylinder. By having the ceramic rings or segments, providing steering capacitance, within the vacuum interrupter their lifespan is increased.

Referring to FIG. 5, the development is similar to that shown in FIG. 4, but now four internal ceramic rings or segments are provided two in series on either side of the middle shield, providing capacitances C12 and C13 on one side and C22 and C23 for the detailed embodiment shown. Having increased numbers of ceramic rings or segments in series provides for increased flexibility of the capacitive distribution and has particular utility when the middle shielding is formed from multiple shields.

Referring to FIG. 6, the development is similar to that shown in FIG. 4, but there is only one internal ceramic ring or segment on one side of the middle shield. It is to be noted that a ceramic ring or segment can be considered to have a capacitance equal to εA/d, where ε is the permittivity equal to ε0 x εr (relative permittivity), A is the cross-section area and d is the length of the ceramic ring or segment between the two metalized ends.

In an example, a further ceramic ring or segment of the one or more ceramic rings or segments located between the middle shield and the contact end cap is located internal to the ceramic housing or as the external housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the second contact end cap at both end cap or at the vacuum interrupter.

An example vacuum interrupter comprises a first contact; a second contact; a middle shield; a first contact end cap; a second contact end cap; and a ceramic housing. The first contact is configured to be held at a first potential when the first contact and the second contact are separated from one another. The second contact is configured to be held at a second potential when the first contact and the second contact are separated from one another. The first contact end cap is configured to be held at the first potential when the first contact and the second contact are separated from one another. The second contact end cap is configured to be held at the second potential when the first contact and the second contact are separated from one another. The middle shield is configured to be held at floating potential. The middle shield is located around a region between the first contact and the second contact, (sometimes and in the case of a multi-shield arrangement there are many shielding placed as well). The ceramic housing is located between the first contact end cap and the second contact end cap. The ceramic housing comprises a first ceramic ring or segment located between the middle shield and the first contact end cap, the first ceramic ring or segment comprises at least one capacitive structure, and the ceramic housing comprises a second ceramic ring or segment located between the middle shield and the first contact end cap. A capacitive structure of the first ceramic ring or segment comprises that a first end face of the first ceramic ring or segment is metalized and electrically connected to the middle shield (in case of several shielding there are in between all the shields metallized ceramic rings placed or at least some based on capacitive steering need). A capacitive structure of the first ceramic ring or segment comprises that a second end face of the first ceramic ring or segment is metalized and electrically connected to a first end face of the second ceramic ring or segment.

It is to be noted that reference to a middle shield can mean that there is a single middle shield element or that the middle shield is formed as a multi shield arrangement.

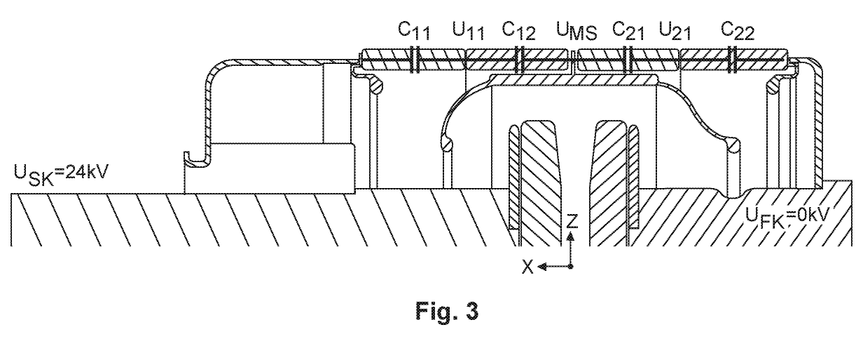

It is to be noted that a ceramic ring or segment can mean a complete ceramic ring or ceramic segment or part of a ceramic ring or ceramic segment. Thus, the ceramic housing has a first ceramic ring or segment that acts in effect as a parallel plate capacitor, having metalized ends, as shown in FIG. 3.

In an example, the second ceramic ring or segment comprises at least one capacitive structure. A capacitive structure of the second ceramic ring or segment comprises that a second end face of the second ceramic ring or segment opposite to the first end face of the second ceramic ring or segment is metalized and electrically connected to the first contact end cap. Thus, the ceramic housing has a first ceramic ring or segment and the second ceramic ring or segment that act in effect as parallel plate capacitors in series, having metalized ends, as shown in FIG. 3.

Referring to FIG. 3, the standard ceramic housing has been replaced with two ceramic rings or segments in series with metalized ends that are between the first contact end cap the midpoint of the middle shield and that provide capacitances C11 and C12 and with two ceramic rings or segments in series with metalized ends that are between the second contact end cap the midpoint of the middle shield and that provide capacitances C21 and C22. Thus, several ceramic rings or segments have been added to generate capacitances within the design. Each capacitance is incorporated into a ceramic ring or segment in the cylinder wall. Metallization at U11, UMS, and U21 has been introduced to achieve the capacitances (C11, C12, C21, C22) for steering purposes.

It is to be noted that a ceramic ring or segment can be considered to have a capacitance equal to εA/d, where ε is the permittivity equal to ε0 x εr (relative permittivity), A is the cross-section area and d is the length of the ceramic ring or segment between the two metalized ends.

In an example, the ceramic housing comprises a third ceramic ring or segment located between the middle shield and the second contact end cap, and the third ceramic ring or segment comprises at least one capacitive structure. The ceramic housing comprises a fourth ceramic ring or segment located between the middle shield and the second contact end cap. A capacitive structure of the third ceramic ring or segment comprises that a first end face of the third ceramic ring or segment is metalized and electrically connected to the middle shield. A capacitive structure of the third ceramic ring or segment comprises that a second end face of the third ceramic ring or segment is metalized and electrically connected to a first end face of the fourth ceramic ring or segment. Thus, the third ceramic ring or segment acts in effect as a parallel plate capacitor, having metalized ends.

In an example, the fourth ceramic ring or segment comprises at least one capacitive structure. A capacitive structure of the fourth ceramic ring or segment comprises that a second end face of the fourth ceramic ring or segment opposite to the first end face of the fourth ceramic ring or segment is metalized and electrically connected to the second contact end cap. Thus, the third ceramic ring or segment and the fourth ceramic ring or segment act in effect as parallel plate capacitors in series, having metalized ends.

In an example, the first contact is a movable contact SK and the second contact is a fixed contact FK.

In an example, the vacuum interrupter comprises at least one ceramic ring or segment, wherein each of the at least one ceramic ring or segment comprises at least one capacitive structure; and wherein one or more ceramic rings or segments of the at least one ceramic ring or segment is located between the middle shield and the first contact end cap and/or wherein one or more ceramic rings or segments of the at least one ceramic ring or segment is located between the middle shield and the second contact end cap.

In an example, a ceramic ring or segment of the one or more ceramic rings or segments located between the middle shield and the first contact end cap is located external to the ceramic housing, and wherein a capacitive structure of the ceramic ring or segment comprises at least one metalized cylindrical surface.

Located external to the ceramic housing means located outside of the ceramic housing, in that the ceramic housing is spaced a first radial distance from a centre axis of the vacuum interrupter and the ceramic ring or segment located external to the ceramic housing is then located such that it is spaced a second radial distance from the centre axis of the vacuum interrupter that is greater than the first radial distance.

In an example, wherein the least one metalized cylindrical surface of the ceramic ring or segment located external to the ceramic housing comprises an inward facing surface.

In an example, the inward facing surface is within a groove in the ceramic ring or segment.

In an example, the at least one metalized cylindrical surface of the ceramic ring or segment located external to the ceramic housing comprises an outward facing surface.

In an example, the outward facing surface is within a groove in the ceramic ring or segment located external to the ceramic housing.

In an example, a first end face of the ceramic ring or segment located external to the ceramic housing is metalized and electrically connected to the middle shield and a second end face of the ceramic ring or segment located external to the ceramic housing opposite to the first end face is metalized and electrically connected to the first contact end cap.

In an example, a capacitive structure is formed between the at least one metalized cylindrical surface of the ceramic ring or segment located external to the ceramic housing and the first end face of the ceramic ring or segment located external to the ceramic housing.

In an example, a capacitive structure is formed between the at least one metalized cylindrical surface of the ceramic ring or segment located external to the ceramic housing and the second end face of the ceramic ring or segment located external to the ceramic housing.

In an example, a capacitive structure comprises at least one further metalized cylindrical surface of the ceramic ring or segment located external to the ceramic housing.

In an example, the least one further metalized cylindrical surface of the ceramic ring or segment located external to the ceramic housing comprises an inward facing surface concentric ceramic ring, (here there can be some concentric rings or segments in each other providing the capacitance).

In an example, the inward facing surface is within a further groove in the ceramic ring or segment located external to the ceramic housing.

In an example, the at least one further metalized cylindrical surface of the ceramic ring or segment located external to the ceramic housing comprises an outward facing surface.

In an example, the outward facing surface is within a further groove in the ceramic ring or segment located external to the ceramic housing, (inside the ceramic surface wall is even possible).

In an example, a further capacitive structure is formed between the at least one metalized cylindrical surface of the ceramic ring or segment located external to the ceramic housing and the at least one further metalized cylindrical surface of the first ceramic ring or segment.

In an example, a capacitive structure is formed between the at least one further metalized cylindrical surface of the ceramic ring or segment located external to the ceramic housing and the second end face of the first ceramic ring or segment. Thus, an externally located ceramic ring or segment located between the middle shield and the first contact end cap acts as one or more capacitors, where one or more capacitors can be formed between a metalized groove in the ceramic ring or segment and a metallized end face of the ceramic ring or segment that is connected to the middle shield, and between metalized grooves themselves, and between a metalized groove in the ceramic ring or segment and a metallized end face of the ceramic ring or segment that is connected to the first contact end cap, as shown in FIG. 2.

In other words, a new ceramic housing formed from multiple ceramic rings or segments as shown in FIG. 3 can also have an outer set of ceramic rings or segments, as shown in FIG. 2, to further provide for capacitive steering.

In an example, a ceramic ring or segment of the one or more ceramic rings or segments located between the middle shield and the second contact end cap is located external to the ceramic housing, and wherein the capacitive of the ceramic ring or segment comprises at least one metalized cylindrical surface.

In an example, the least one metalized cylindrical surface of the ceramic ring or segment located external to the ceramic housing and located between the middle shield and the second contact end cap comprises an inward facing surface.

In an example, the inward facing surface is within a groove in the ceramic ring or segment located external to the ceramic housing and located between the middle shield and the second contact end cap.

In an example, the least one metalized cylindrical surface of the ceramic ring or segment located external to the ceramic housing and located between the middle shield and the second contact end cap comprises an outward facing surface.

In an example, the outward facing surface is within a groove in the ceramic ring or segment located external to the ceramic housing and located between the middle shield and the second contact end cap.

In an example, a first end face of the ceramic ring or segment located external to the ceramic housing and located between the middle shield and the second contact end cap is electrically connected to the middle shield and a second end face of the ceramic ring or segment located external to the ceramic housing and located between the middle shield and the second contact end cap opposite to the first end face is electrically connected to the second contact end cap.

In an example, a capacitive structure is formed between the at least one metalized cylindrical surface of the ceramic ring or segment located external to the ceramic housing and located between the middle shield and the second contact end cap and the first end face of the ceramic ring or segment located external to the ceramic housing and located between the middle shield and the second contact end cap.

In an example, a capacitive structure is formed between the at least one metalized cylindrical surface of the ceramic ring or segment located external to the ceramic housing and located between the middle shield and the second contact end cap and the second end face of the ceramic ring or segment located external to the ceramic housing and located between the middle shield and the second contact end cap. Thus, in case of a multi shield arrangement are in between the selected shield these ceramic rings or segments are located.

In an example, a capacitive structure comprises at least one further metalized cylindrical surface of the ceramic ring or segment located external to the ceramic housing and located between the middle shield and the second contact end cap.

In an example, the least one further metalized cylindrical surface of the ceramic ring or segment located external to the ceramic housing and located between the middle shield and the second contact end cap comprises an inward facing surface.

In an example, the inward facing surface is within a further groove in the ceramic ring or segment located external to the ceramic housing and located between the middle shield and the second contact end cap.

In an example, the at least one further metalized cylindrical surface of the ceramic ring or segment located external to the ceramic housing and located between the middle shield and the second contact end cap comprises an outward facing surface.

In an example, the outward facing surface is within a further groove in the ceramic ring or segment located external to the ceramic housing and located between the middle shield and the second contact end cap.

In an example, a further capacitive structure is formed between the at least one metalized cylindrical surface of the ceramic ring or segment located external to the ceramic housing and located between the middle shield and the second contact end cap and the at least one further metalized cylindrical surface of the ceramic ring or segment located external to the ceramic housing and located between the middle shield and the second contact end cap.

In an example, a further capacitive structure is formed between the at least one further metalized cylindrical surface of the ceramic ring or segment located external to the ceramic housing and located between the middle shield and the second contact end cap and the second end face of the ceramic ring or segment located external to the ceramic housing and located between the middle shield and the second contact end cap. Thus, an externally located ceramic ring or segment located between the middle shield and the second contact end cap acts as one or more capacitors, where one or more capacitors can be formed between a metalized groove in the ceramic ring or segment and a metallized end face of the ceramic ring or segment that is connected to the middle shield, and between metalized grooves themselves, and between a metalized groove in the ceramic ring or segment and a metallized end face of the ceramic ring or segment that is connected to the second contact end cap. This is shown in FIG. 2, which now sits with the design shown in FIG. 3.

In an example, a ceramic ring or segment of the one or more ceramic rings or segments located between the middle shield and the first contact end cap is located internal to the ceramic housing. A capacitive structure of the ceramic ring or segment comprises that a first end face of the first ceramic ring or segment is metalized and electrically connected to the middle shield.

Located internal to the ceramic housing means located inside of the ceramic housing, in that the ceramic housing is spaced the first radial distance from the centre axis of the vacuum interrupter and the ceramic ring or segment located internal to the ceramic housing is then located such that it is spaced a third radial distance from the centre axis of the vacuum interrupter that is less than the first radial distance.

In an example, a capacitive structure of the ceramic ring or segment located internal to the ceramic housing comprises that a second end face of the ceramic ring or segment opposite to the first end face of the ceramic ring or segment is metalized and electrically connected to the first contact end cap. Thus, the internal ceramic ring or segment in effect acts as a parallel plate capacitor with metalized ends. This is shown in FIGS. 4 and 6, which now sits with the design of FIG. 2.

In an example, a further ceramic ring or segment of the one or more ceramic rings or segments located between the middle shield and the first contact end cap is located internal to the ceramic housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the first contact end cap.

In case of a Multi-shield arrangement the ceramic ring or segment can be added in between all or partly on shields. In addition, the inner shield structure can be fixed on the inner capacitor rings or segments, the outer ceramic can be selected as one part or at least two parts. The shield is fixed on the inner ceramic ring or segment structure, maybe a vacuum interrupter with one shielding or even with several of those. The outer ceramic insulator ring or segment can be one part from fixed to movable side, or also at least made of two single cylinder parts. Thus, the internal ceramic rings or segments in effect act as parallel plate capacitors in series with metalized ends. This is shown in FIG. 5, which now sits with the design of FIG. 2.

In an example, a ceramic ring or segment of the one or more ceramic rings or segments located between the middle shield (or in between all shielding in case of Multi-shield design) and the second contact end cap is located internal to the ceramic housing, and a capacitive structure of the ceramic ring or segment comprises that a first end face of the ceramic ring or segment is metalized and electrically connected to the middle shield (or to all which are located and on floating potential).

In an example, a capacitive structure of the ceramic ring or segment located internal to the ceramic housing and located between the middle shield and the second contact end cap comprises that a second end face of the ceramic ring or segment opposite to the first end face of the ceramic ring or segment is metalized and electrically connected to the second contact end cap. Thus, the internal ceramic ring or segment in effect acts as a parallel plate capacitor with metalized ends. This is shown in FIGS. 4 and 6, which now sits with the design of FIG. 2.

In an example, a further ceramic ring or segment of the one or more ceramic rings or segments located between the middle shield and the second contact end cap is located internal to the ceramic housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the second contact end cap. Thus, the internal ceramic rings or segments in effect act as parallel plate capacitors in series with metalized ends. This is shown in FIG. 5, which now sits with the design of FIG. 2.

Maintaining a homogeneous potential along the vacuum interrupter, especially considering the outer side and gas atmosphere, is crucial for reliable insulation, efficient current interruption, and the ability to withstand high voltages. The capacitance of elements of the vacuum interrupter play an important role in achieving this uniform voltage distribution, ensuring safe and efficient operation of vacuum interrupter.

At present the inventors, regarding the role of capacitance, started from the position of understanding what effect the intrinsic capacitance of elements of the vacuum interrupter had on the voltage distribution, and realized that they could augment the intrinsic capacitance through the judicious placement of ceramic rings or segments, internally within the vacuum interrupter (internal to the normal ceramic housing) and/or external to the normal ceramic housing, and that the normal ceramic housing itself could be replaced with ceramic rings or segments. The ceramic rings or segments that are utilized have been modified in order that they have capacitive structures that provide for capacitance of the required magnitude at the correct locations to ensure a uniform voltage distribution. Thus, the inventors considered the following regarding the role of capacitors with respect to a vacuum interrupter.

Capacitors play a crucial role in maintaining a homogeneous voltage distribution along the entire vacuum interrupter.

Outer Side Consideration: When the vacuum interrupter is exposed to a gas atmosphere (such as air), ensuring uniform voltage distribution on the outer side becomes essential.

Capacitor Stack: By using a capacitor or a stack of capacitors, the voltage distribution can be controlled more effectively.

Homogenizing Potential: Capacitors help distribute the voltage evenly across the interrupter, minimizing any localized high electric fields.

Preventing Surface Flashover: Uneven voltage distribution on the outer side will lead to surface flashover (unintended electrical discharge along the surface). Surface flashover can compromise the interrupter’s performance and safety.

Gas Insulation: The outer shield, guided by capacitors, provides additional insulation against the surrounding gas atmosphere, preventing unwanted breakdown or arcing.

Overall Performance: A well-designed capacitor system ensures that the voltage distribution remains uniform both inside and outside the vacuum interrupter, enhancing its ability to withstand high voltages.

As part of the inventor’s design process, they considered the fascinating interplay between a vacuum interrupter, capacitors, and the ceramic housing, especially when it comes to voltage distribution and high-voltage performance, and thus in addition to the above points the inventors also considered the following:

Ceramic Housing: The ceramic housing of the vacuum interrupter provides several benefits:

Insulation: The ceramic material acts as an excellent insulator, preventing electrical leakage and ensuring safety.

Mechanical Support: The ceramic housing supports the internal components, including the electrical contacts and capacitors.

Integration: By integrating capacitors directly into the ceramic housing, designers achieve a compact and efficient solution.

Capacitor Stack: The capacitors are strategically placed within the ceramic envelope to steer the voltage distribution:

Capacitors help distribute the voltage evenly across the interrupter, minimizing any localized high electric fields.

They ensure that the electric field remains uniform both inside and outside the vacuum interrupter.

The capacitors counteract any uneven voltage distribution caused by the gas atmosphere surrounding the interrupter.

Homogenizing Potential: The combined effect of capacitors and ceramic housing results in a more homogeneous potential along the entire vacuum interrupter, enhancing its ability to withstand high voltages.

The integration of capacitors within the ceramic body of a vacuum interrupter plays a vital role in achieving uniform voltage distribution, especially on the outer side exposed to a gas atmosphere. This design ensures safe and efficient operation, making vacuum interrupters indispensable for modern electrical systems.

The inventors then considered the following regarding the differences between having a capacitor as a separate stack versus integrating it into the ceramic body of the vacuum interrupter:

Separate Capacitor Stack:

Design: In this approach, the capacitor is physically separate from the vacuum interrupter. It exists as an independent component, often mounted externally to the interrupter housing.

Functionality: The separate capacitor stack serves the same purpose as any other capacitor in an electrical circuit. By introducing capacitors, the current leads the voltage in phase, improving overall system efficiency.

Advantages:

Flexibility: The separate stack allows for easy replacement or maintenance of individual capacitors.

Customization: Different capacitor values can be combined to achieve specific correction of voltage distribution.

Accessibility: External mounting makes inspection and replacement straightforward.

Considerations:

Space: Requires additional space for mounting the stack.

Wiring: Requires separate wiring or E-filed steering connections between the capacitor stack and the vacuum interrupter.

Integrated Capacitor in Ceramic Body:

Design: In this approach, the capacitor is directly integrated into the ceramic body of the vacuum interrupter.

The ceramic housing itself contains the necessary capacitive elements.

Functionality: The integrated capacitor serves the same purpose as the separate stack: E-filed steering and correction of unbalanced voltage potential distribution. However, it is seamlessly incorporated into the interrupter’s design.

Advantages:

Compactness: No additional space is needed; the capacitor is part of the interrupter.

Simplified Design: Fewer external components and connections.

Enhanced Reliability: Reduced risk of external damage or disconnection.

Uniform Voltage Distribution: The capacitor contributes to even voltage distribution both inside and outside the interrupter.

Considerations:

Limited Customization: Capacitor value may be fixed based on the interrupter’s design.

Maintenance: If the integrated capacitor fails, the entire interrupter may need replacement.

Overall Importance: Regardless of the approach, maintaining uniform voltage distribution within the vacuum interrupter is crucial. Capacitors play a vital role in achieving this uniformity, ensuring safe and efficient operation.

Summary: The choice between a separate capacitor stack and an integrated capacitor depends on factors such as space availability, customization needs, and easiness of maintenance. Both approaches contribute to efficient voltage distribution systems by managing the voltage potential along the vacuum interrupter and enhancing overall performance.

The new developments provide the following:

Flexibility and Adaptability: Modular designs allow for easy reconfiguration, expansion, or relocation of components within the vacuum interrupter, compared to FIGS. 1a and 1b. This adaptability is beneficial for evolving requirements or future upgrades, generating different versions for many applications in medium- and high- voltage.

Cost Efficiency: Manufacturing modules in a controlled environment within the vacuum interrupter reduces waste and labor costs. Since all components are included inside the vacuum interrupter, it can be used in silicone, tank designs, or tubular arrangements without needing additional external components. This integration simplifies installation and connection, while faster construction times also lower site costs and financing expenses.

Quality Control: Building modules in a factory setting ensures higher quality control, reducing the risk of defects caused by external factors like cable or terminal connection to the vacuum interrupter on side.

Sustainability: Modular designs promote sustainability through efficient use of materials and reduced waste. Factories can use known materials and use sustainable practices, minimizing environmental impact. No additional plastic insulation material is needed for capacitors, as modern vacuum technology provides dielectric steering using well-known components acting as capacitors to manage the voltage potential along the vacuum interrupter.

Accelerated Construction Time: Simultaneous manufacturing of modules and site preparation will significantly reduce the overall construction timeline, which is particularly beneficial for many / multiple projects.

Scalability: Modular designs are inherently scalable, allowing for easy expansion by adding no more or larger modules if needed.

Thus, the new developments provide the following:

Vacuum interrupters have a long operational life and require minimal maintenance, enhancing the reliability of the switchgear, the safety is on the higher side because of the absence of toxic gases, and the robust design of vacuum interrupters contribute to higher safety standards for both operators and the environment.

The compact and modular design of the vacuum interrupter, with intrinsic and capacitive steering elements, fits into existing switchgear configurations without significant modifications. Thus, the outer geometry remains unchanged, eliminating the need for alterations during embedding processes, such as those involving silicone, thermoplastic poles, epoxy poles, or other technologies used for mechanical fixation or insulation.

However, there are methods to achieve the same capacitive steering of the vacuum interrupter within a ceramic embodiment. In this case, the outer structure is adjusted. Thus, these benefits make the new development of intrinsic and modular designs a compelling choice for a wide range of applications, from medium- voltage vacuum interrupters to complex high-voltage systems.

The following provides details on detailed embodiments of the new developments, with reference to the figures, and details in effect the journey undertaken by the inventors in arriving at the new developments.

FIG. 1a shows a standard single contact gap vacuum interrupter, e.g. type VG6-S, and in FIG. 1b the shows the modelled E-Field of a situation where the vacuum interrupter is "free-standing", i.e., with nothing located near to the vacuum interrupter, and thus this situation is somewhat artificial.

The inventors started from this situation, modelling the E-field equipotential lines for a standard vacuum interrupter, to determine the voltage distribution along the device, with a particular focus on the floating middle potential.

In FIGS. 1a and 1b, the voltage distribution, particularly at the middle shielding, is not perfectly balanced. Rather, the voltage distribution USK/MS/UFK/MS is 56.4% / 43.6% due to the slightly asymmetrical shield design, where the ideal would be 50% / 50%. In FIGS. 1a and 1b the capacitances C1, C2, and C3 are inherent capacitances of the vacuum interrupter structure. Thus, the inventors realized that structures could be added, in effect internally and/or externally to the body of the vacuum interrupter to add capacitances to seek to modify the voltage distribution towards the ideal.

Thus, FIG. 2 shows a new single contact gap design, where the inventors have added areas with capacitances included in the design. Each capacitance is incorporated into a separate ceramic embodiment or the ceramic cylinder wall. In the groove areas (U11, U12, U21, U22) of the ceramic cylinder, metallization has been introduced to achieve the capacitance (C11, C12, C13/C21, C22, C23) for steering purposes. The intrinsic capacitances as described with respect to FIG. 1 are also present but can be modified.

Thus, referring to FIG. 2, the ceramic housing is still present but two further ceramic rings or segments have been added that are external to the ceramic housing, one between the first contact end cap and the mid-point of the middle shield and the second between the second contact end cap and the mid-point of the middle shield. It is to be noted, that in effect the intrinsic capacitances C1, C2, and C3, as shown in FIGS. 1a and 1b are still present but additional steering capacitances have been added to provide a more homogeneous voltage distribution. Specifically, areas with capacitances included in the design have been added. Each capacitance is incorporated into a separate ceramic embodiment or the ceramic cylinder wall. In the groove areas (U11, U12, U21, U22) of the ceramic cylinder, metallization has been introduced to achieve the capacitance (C11, C12, C13/C21, C22, C23) for steering purposes. In FIG. 2 metallization is shown on the outer surface, but this can also or alternatively be on the inner surface. This can be achieved by using metal (silver) painting lacquer or coating by PVD/CVD technology. The metallization can be done before production of the vacuum interrupter and for the external coating can be done after production.

Thus, FIG. 3 shows a new ingle contact gap design, where the inventors have added several ceramic rings or segments to generate capacitances within the design. Each capacitance is incorporated into a ceramic ring or segment in the cylinder wall. Metallization at U11, UMS, and U21 has been introduced to achieve the capacitances (C11, C12, C21, C22) for steering purposes. The short ceramic tubes are “acting” like capacitors, such that C can be considered as C = εA/d, where ε is the permittivity equal to ε0 x εr (relative permittivity), A is the cross-section area and d is the length of the ceramic ring or segment between the two metalized ends. The intrinsic capacitances as described with respect to FIG. 1 are also present but can be modified.

Referring to FIG. 3, the standard ceramic housing has been replaced with two ceramic rings or segments in series with metalized ends that are between the first contact end cap the mid-point of the middle shield and that provide capacitances C11 and C12 and with two ceramic rings or segments in series with metalized ends that are between the second contact end cap the mid-point of the middle shield and that provide capacitances C21 and C22. Thus, several ceramic rings or segments have been added to generate capacitances within the design. Each capacitance is incorporated into a ceramic ring or segment in the cylinder wall. Metallization at U11, UMS, and U21 has been introduced to achieve the capacitances (C11, C12, C21, C22) for steering purposes.

FIG. 4 shows an advantageous design, of a new single contact gap design, that is in effect a modular approach that includes ceramic rings or segments, both additional and intrinsic, in the vacuum interrupter embodiment to generate capacitances within the design. Each capacitance is incorporated as a ceramic ring / or as a segment “ring”, positioned between the floating shield and one potential to purposefully steer the middle potential. The ceramic ring or segment can be placed as needed, with the option to use none, one, or two rings or segments. Additionally, different capacitances can be installed to adjust the steering at the middle potential, depending on the thickness of the capacitance or the shape of the inner capacitance cylinder. In this design the outer shape of vacuum interrupter can be kept unchanged.

Thus, referring to FIG. 4, the ceramic housing is still present but two further ceramic rings or segments have been added that are internal to the ceramic housing, one between the first contact end cap and the middle shield and the second between the second contact end cap and the middle shield. It is to be noted, that in effect the intrinsic capacitances C1, C2, and C3, as shown in FIGS. 1a and 1b are still present, where the intrinsic capacitances associated with the two parts of the ceramic housing are shown as C11, C21 in FIG. 4. But additional steering capacitances have been added to provide a more homogeneous voltage distribution in the form of two internal ceramic rings or segments that have metalized end faces, and associated capacitances of C12 and C22 for the detailed embodiment shown in FIG. 4. Specifically, each capacitance is incorporated as a ceramic ring / or as a segment “ring”, positioned between the floating shield and one potential to purposefully steer the middle potential. The ceramic ring or segment can be placed as needed, with the option to use none, one, or two rings or segments. Additionally, different capacitances can be installed to adjust the steering at the middle potential, depending on the thickness of the capacitance or the shape of the inner capacitance cylinder. By having the ceramic rings or segments, providing steering capacitance, within the vacuum interrupter their lifespan is increased.

FIG. 5 then shows the case where there can be pairs of ceramic rings or segments in series, or as shown in FIG. 5 just one internal ceramic ring or segment as required to provide the required capacitance.

Referring to FIG. 5, the development is similar to that shown in FIG. 4, but now four internal ceramic rings or segments are provided two in series on either side of the middle shield, providing capacitances C12 and C13 on one side and C22 and C23 for the detailed embodiment shown. Having increased numbers of ceramic rings or segments in series provides for increased flexibility of the capacitive distribution and has particular utility when the middle shielding is formed from multiple shields.

Thus: To achieve higher capacitance values, the inventors used larger cylinders with full metallization on both faces. Metallized ZrO₂ can be used in capacitors due to its high electrical insulation capability and thermal stability, as well as its higher dielectric constant (value ɛr around 29) compared to Al₂O₃ (value ɛr around 9) ceramic. However, other ceramics can also be considered, with a cost-competitive solution balancing advantages and costs.

Ceramic rings or segments can be connected in series - see FIG. 5. One ceramic is placed on the middle shield only – see Fig, 6.

Referring to FIG. 6, the development is similar to that shown in FIG. 4, but there is only one internal ceramic ring or segment on one side of the middle shield. It is to be noted that a ceramic ring or segment can be considered to have a capacitance equal to εA/d, where ε is the permittivity equal to ε0 x εr (relative permittivity), A is the cross-section area and d is the length of the ceramic ring or segment between the two metalized ends.

To reduce capacitance, cylinders with reduced wall thickness can be used. Conical shapes can also be used, though not shown here. Additionally, to increase capacitance, the design of the additional and inner cylinders can be shaped like the part shown in FIG. 2, with grooves on the outside and metallization, but applied to the inner modular applied ceramic cylinder part.

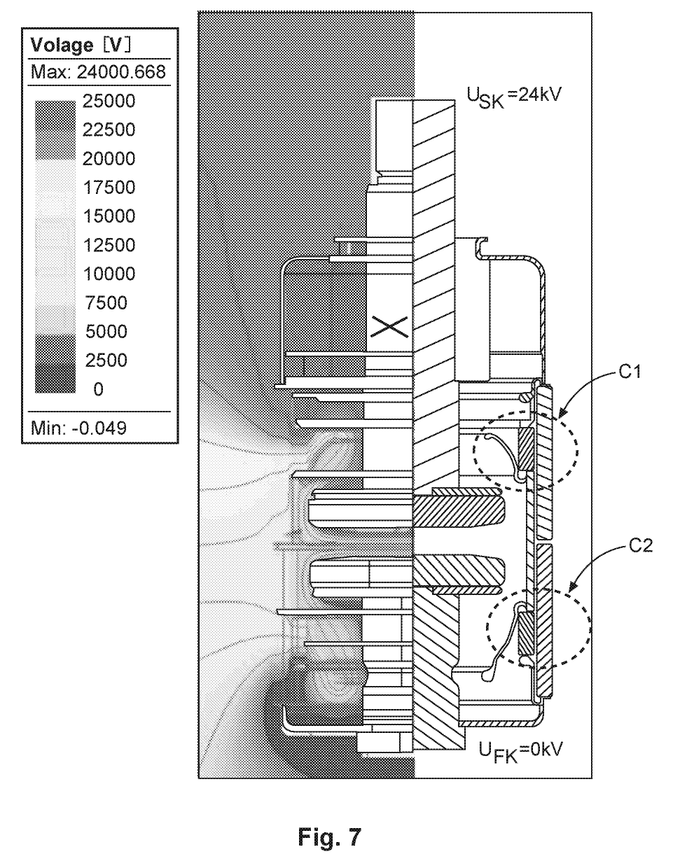

FIG. 7 in effect shows the E-Field of the "free-standing" vacuum interrupter of in effect FIG. 4, with overall steering capacitances C1 and C2 with ɛr = 30 or selected a ceramic type with higher ɛr. The voltage distribution along the vacuum interrupter for this “free-standing” situation is USK/MS/UFK/MS = 52% / 48%.

However, the “free-standing” does not represent reality, and the inventors modelled the E-Field of vacuum interrupters where an earthed plate is placed close to the vacuum interrupter.

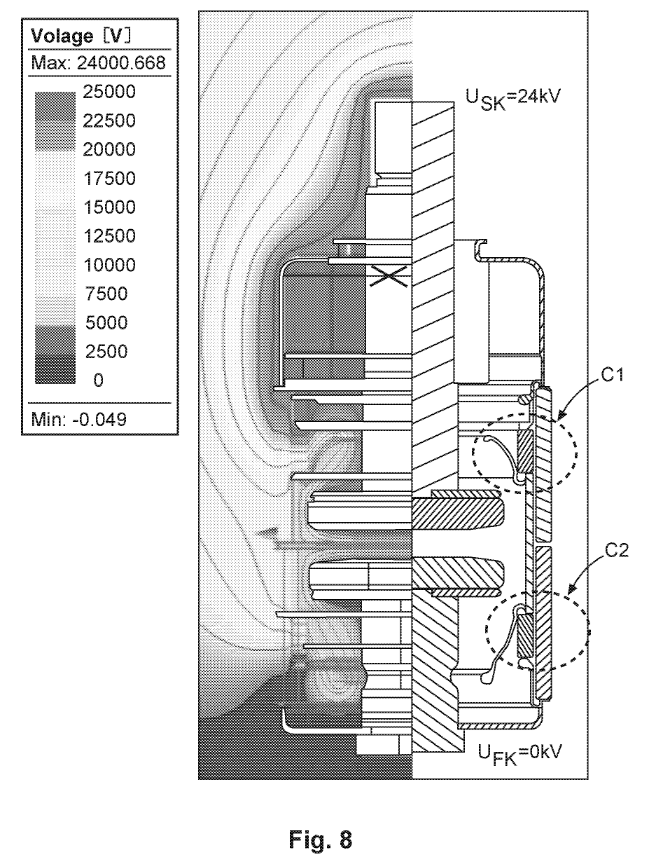

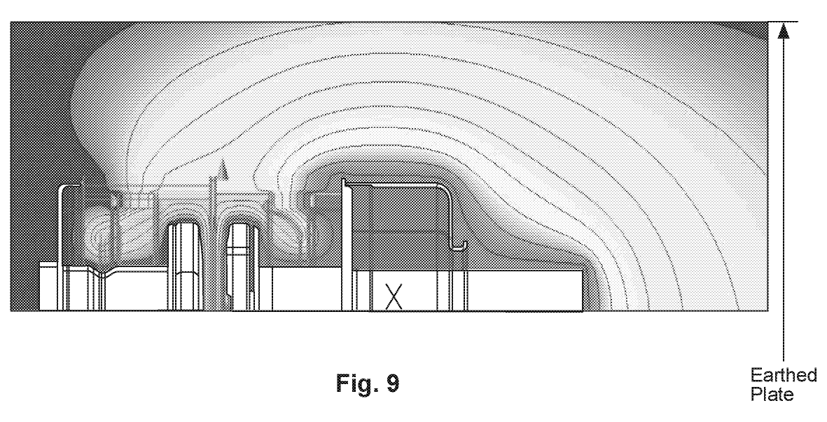

This is shown in FIGS. 8 and 9, that show the E-Field for the vacuum interrupter shown FIG. 7, but now where an earther plate has been placed 100mm from the ceramic wall. Again, overall steering capacitances C1 and C2 with ɛr = 30. However, now the voltage distribution along the vacuum interrupter for this “real” situation is USK/MS/UFK/MS = 53.5% / 46.5%. Thus, a design process for a switchgear can be envisaged as follows. For a particular switchgear, where all the components within the switchgear, for example walls and internal parts at earth potential, the E-Field within the vacuum interrupter can be modelled and the required internal ceramic rings or segments as shown in for example FIGS. 4, 5 and 6, are determined that can be internal to the normal ceramic housing. The Vacuum interrupter can then be a normal size, where the ceramic rings or segments will be within the vacuum of the overall vacuum interrupter. The voltage distribution along the vacuum interrupter could then be driven towards the ideal of 50% / 50%.

However, if the switchgear was modified in the future in some way, such as an additional strut at earth potential was needed to be located near to the vacuum interrupter, then the voltage distribution along the vacuum interrupter would be driven away from the ideal. Further modelling could then be performed, and external ceramic rings or segments as described with respect to FIGS. 2 and 3 could then be added externally to the vacuum interrupter vacuum tight body to modify the voltage distribution along the vacuum interrupter back towards the ideal of 50 % / 50%.

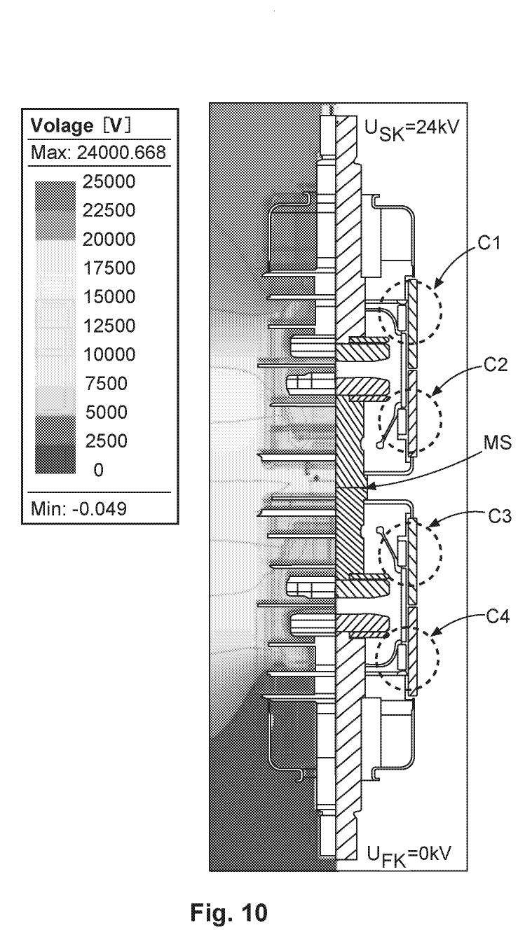

FIG. 10 shows a double contact gap design, indicating that the new development can be applied to such double contact gap design too. Again, there is a modular approach that includes ceramic rings or segments, both additional and intrinsic, in the vacuum interrupter embodiment to generate capacitances C1, C2, C3 and C4 within the design. Each capacitance is incorporated as a ceramic ring or segment. The displayed E-Field of the "free-standing" vacuum interrupter shows a voltage distribution of 50%/50%.

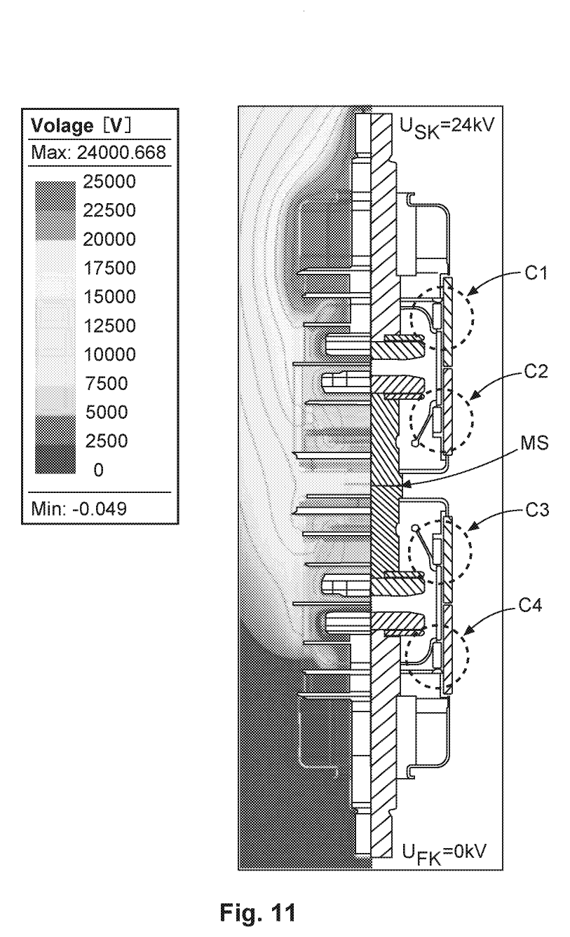

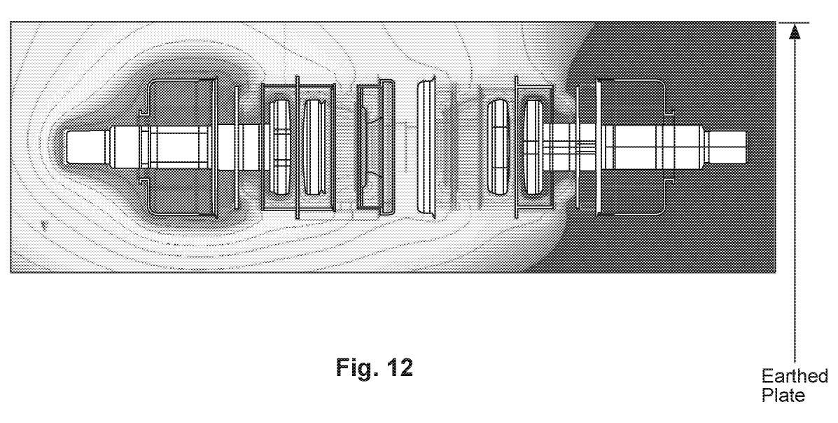

FIGS. 11 and 12 show the double contact gap design of FIG. 10, but again with an earthed plate 100mm from the ceramic. The displayed E-Field of the vacuum interrupter shows a voltage distribution of 54.6%/45.4%, which is still close to the ideal 50/50 distribution. This is quite different from the current situation, where a voltage distribution of 70%/30% would have been observed without the extra capacitive steering elements.

In the context of the present disclosure, reference to a middle shield can mean that there is a single middle shield element or that the middle shield is formed as a multi shield arrangement. It is to be noted that a ceramic ring or segment can mean a complete ceramic ring or ceramic segment or part of a ceramic ring or ceramic segment.

In an example, the first contact is a movable contact (SK) and the second contact is a fixed contact (FK). In an example, a ceramic ring or segment of the one or more ceramic rings or segments located between the middle shield and the first contact end cap is located external to the ceramic housing, and a capacitive structure of the ceramic ring or segment comprises at least one metalized cylindrical surface.

Located external to the ceramic housing means located outside of the ceramic housing, in that the ceramic housing is spaced a first radial distance from a center axis of the vacuum interrupter and the ceramic ring or segment located external to the ceramic housing is then located such that it is spaced a second radial distance from the center axis of the vacuum interrupter that is greater than the first radial distance.

In an example, the least one metalized cylindrical surface of the ceramic ring or segment located external to the ceramic housing comprises an inward facing surface. In an example, the inward facing surface is within a groove in the ceramic ring or segment. In an example, the at least one metalized cylindrical surface of the ceramic ring or segment located external to the ceramic housing comprises an outward facing surface. In an example, the outward facing surface is within a groove in the ceramic ring or segment located external to the ceramic housing. In an example, a first end face of the ceramic ring or segment located external to the ceramic housing is metalized and electrically connected to the middle shield and a second end face of the ceramic ring or segment located external to the ceramic housing opposite to the first end face is metalized and electrically connected to the first contact end cap.

In an example, a capacitive structure is formed between the at least one metalized cylindrical surface of the ceramic ring or segment located external to the ceramic housing and the first end face of the ceramic ring or segment located external to the ceramic housing. In an example, a capacitive structure is formed between the at least one metalized cylindrical surface of the ceramic ring or segment located external to the ceramic housing and the second end face of the ceramic ring or segment located external to the ceramic housing. In an example, a capacitive structure comprises at least one further metalized cylindrical surface of the ceramic ring or segment located external to the ceramic housing. In an example, the least one further metalized cylindrical surface of the ceramic ring or segment located external to the ceramic housing comprises an inward facing surface.

In an example, the inward facing surface is within a further groove in the ceramic ring or segment located external to the ceramic housing. In an example, the at least one further metalized cylindrical surface of the ceramic ring or segment located external to the ceramic housing comprises an outward facing surface. In an example, the outward facing surface is within a further groove in the ceramic ring or segment located external to the ceramic housing. In an example, a further capacitive structure is formed between the at least one metalized cylindrical surface of the ceramic ring or segment located external to the ceramic housing and the at least one further metalized cylindrical surface of the first ceramic ring or segment.

In an example, a capacitive structure is formed between the at least one further metalized cylindrical surface of the ceramic ring or segment located external to the ceramic housing and the second end face of the first ceramic ring or segment. Thus, an externally located ceramic ring or segment located between the middle shield and the first contact end cap acts as one or more capacitors, where one or more capacitors can be formed between a metalized groove in the ceramic ring or segment and a metallized end face of the ceramic ring or segment that is connected to the middle shield, and between metalized grooves themselves, and between a metalized groove in the ceramic ring or segment and a metallized end face of the ceramic ring or segment that is connected to the first contact end cap.

In an example, a ceramic ring or segment of the one or more ceramic rings or segments located between the middle shield and the second contact end cap is located external to the ceramic housing, and wherein a capacitive structure of the ceramic ring or segment comprises at least one metalized cylindrical surface.

In an example, the least one metalized cylindrical surface of the ceramic ring or segment located external to the ceramic housing and located between the middle shield and the second contact end cap comprises an inward facing surface.

In an example, the inward facing surface is within a groove in the ceramic ring or segment located external to the ceramic housing and located between the middle shield and the second contact end cap.

In an example, the least one metalized cylindrical surface of the ceramic ring or segment located external to the ceramic housing and located between the middle shield and the second contact end cap comprises an outward facing surface.

In an example, the outward facing surface is within a groove in the ceramic ring or segment located external to the ceramic housing and located between the middle shield and the second contact end cap.

In an example, a first end face of the ceramic ring or segment located external to the ceramic housing and located between the middle shield and the second contact end cap is electrically connected to the middle shield and a second end face of the ceramic ring or segment located external to the ceramic housing and located between the middle shield and the second contact end cap opposite to the first end face is electrically connected to the second contact end cap.

In an example, a capacitive structure is formed between the at least one metalized cylindrical surface of the ceramic ring or segment located external to the ceramic housing and located between the middle shield and the second contact end cap and the first end face of the ceramic ring or segment located external to the ceramic housing and located between the middle shield and the second contact end cap.

In an example, a capacitive structure is formed between the at least one metalized cylindrical surface of the ceramic ring or segment located external to the ceramic housing and located between the middle shield and the second contact end cap and the second end face of the ceramic ring or segment located external to the ceramic housing and located between the middle shield and the second contact end cap. Thus, in case of a multi shield arrangement are in between the selected shield these ceramic rings or segments are located.

In an example, a capacitive structure comprises at least one further metalized cylindrical surface of the ceramic ring or segment located external to the ceramic housing and located between the middle shield (or many of those shields in case of multi shield design in high voltage) and the second contact end cap.

In an example, the least one further metalized cylindrical surface of the ceramic ring or segment located external to the ceramic housing and located between the middle shield (or middle shielding if selected) and the second contact end cap comprises an inward facing surface.

In an example, the inward facing surface is within a further groove in the ceramic ring or segment located external to the ceramic housing and located between the middle shield and the second contact end cap.

In an example, the at least one further metalized cylindrical surface of the ceramic ring or segment located external to the ceramic housing and located between the middle shield and the second contact end cap comprises an outward facing surface.

In an example, the outward facing surface is within a further groove in the ceramic ring or segment located external to the ceramic housing and located between the middle shield and the second contact end cap.

In an example, a further capacitive structure is formed between the at least one metalized cylindrical surface of the ceramic ring or segment located external to the ceramic housing and located between the middle shield and the second contact end cap and the at least one further metalized cylindrical surface of the ceramic ring or segment located external to the ceramic housing and located between the middle shield and the second contact end cap.

In an example, a further capacitive structure is formed between the at least one further metalized cylindrical surface of the ceramic ring or segment located external to the ceramic housing and located between the middle shield and the second contact end cap and the second end face of the ceramic ring or segment located external to the ceramic housing and located between the middle shield (or the shielding if selected) and the second contact end cap. Thus, an externally located ceramic ring or segment located between the middle shield and the second contact end cap acts as one or more capacitors, where one or more capacitors can be formed between a metalized groove in the ceramic ring or segment and a metallized end face of the ceramic ring or segment that is connected to the middle shield, and between metalized grooves themselves, and between a metalized groove in the ceramic ring or segment and a metallized end face of the ceramic ring or segment that is connected to the second contact end cap.

In an example, a ceramic ring or segment of the one or more ceramic rings or segments located between the middle shield and the first contact end cap is located internal to the ceramic housing, and a capacitive structure of the ceramic ring or segment comprises that a first end face of the first ceramic ring or segment is metalized and electrically connected to the middle shield.

Located internal to the ceramic housing means located inside of the ceramic housing, in that the ceramic housing is spaced the first radial distance from the center axis of the vacuum interrupter and the ceramic ring or segment located internal to the ceramic housing is then located such that it is spaced a third radial distance from the center axis of the vacuum interrupter that is less than the first radial distance.

In an example, a capacitive structure of the ceramic ring or segment located internal to the ceramic housing comprises that a second end face of the ceramic ring or segment opposite to the first end face of the ceramic ring or segment is metalized and electrically connected to the first contact end cap. Thus, the internal ceramic ring or segment in effect acts as a parallel plate capacitor with metalized ends.

In an example, a further ceramic ring or segment of the one or more ceramic rings or segments located between the middle shield (or in case of multiple shielding between all of them or partly between some) and the first contact end cap is located internal to the ceramic housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the first contact end cap. Thus, the internal ceramic rings or segments in effect act as parallel plate (ring/segment) capacitors in series with metalized ends.

In an example, a ceramic ring or segment of the one or more ceramic rings or segments located between the middle shield (or the shielding in case there will be used a multiple shield design) and the second contact end cap is located internal to the ceramic housing, and a capacitive structure of the ceramic ring or segment comprises that a first end face of the ceramic ring or segment is metalized and electrically connected to the middle shield (or the shielding on each the sides for a multi shield design).

In an example, a capacitive structure of the ceramic ring or segment located internal to the ceramic housing and located between the middle shield and the second contact end cap comprises that a second end face of the ceramic ring or segment opposite to the first end face of the ceramic ring or segment is metalized and electrically connected to the second contact end cap. Thus, the internal ceramic ring or segment in effect acts as a parallel plate capacitor with metalized ends.

In an example, a further ceramic ring or segment of the one or more ceramic rings or segments located between the middle shield and the second contact end cap is located internal to the ceramic housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the second contact end cap. Thus, the internal ceramic rings or segments in effect act as parallel plate capacitors in series with metalized ends.

In an example, a further ceramic ring or segment of the one or more ceramic rings or segments located between the middle shield and the contact end cap is located internal to the ceramic housing or as the external housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the second contact end cap of the vacuum interrupter.

In an aspect a vacuum interrupter is provided, comprising: a first contact; a second contact; a middle shield; a first contact end cap; a second contact end cap; and a ceramic housing. The first contact is configured to be held at a first potential when the first contact and the second contact are separated from one another. The second contact is configured to be held at a second potential when the first contact and the second contact are separated from one another. The first contact end cap is configured to be held at the first potential when the first contact and the second contact are separated from one another. The second contact end cap is configured to be held at the second potential when the first contact and the second contact are separated from one another. The middle shield is configured to be held at floating potential. The middle shield is located around a region between the first contact and the second contact, (sometimes and in the case of a multi-shield arrangement there are many shielding placed as well). The ceramic housing is located between the first contact end cap and the second contact end cap. The ceramic housing comprises a first ceramic ring or segment located between the middle shield and the first contact end cap, the first ceramic ring or segment comprises at least one capacitive structure, and the ceramic housing comprises a second ceramic ring or segment located between the middle shield and the first contact end cap. A capacitive structure of the first ceramic ring or segment comprises that a first end face of the first ceramic ring or segment is metalized and electrically connected to the middle shield, (in case of several shielding there are in between all the shields metallized ceramic rings placed or at least some based on capacitive steering need). A capacitive structure of the first ceramic ring or segment comprises that a second end face of the first ceramic ring or segment is metalized and electrically connected to a first end face of the second ceramic ring or segment.

It is to be noted that reference to a middle shield can mean that there is a single middle shield element or that the middle shield is formed as a multi shield arrangement.

It is to be noted that a ceramic ring or segment can mean a complete ceramic ring or ceramic segment or part of a ceramic ring or ceramic segment. Thus, the ceramic housing has a first ceramic ring or segment that acts in effect as a parallel plate capacitor, having metalized ends.

In an example, the second ceramic ring or segment comprises at least one capacitive structure. A capacitive structure of the second ceramic ring or segment comprises that a second end face of the second ceramic ring or segment opposite to the first end face of the second ceramic ring or segment is metalized and electrically connected to the first contact end cap. Thus, the ceramic housing has a first ceramic ring or segment and the second ceramic ring or segment that act in effect as parallel plate capacitors in series, having metalized ends.

In an example, the ceramic housing comprises a third ceramic ring or segment located between the middle shield and the second contact end cap, and the third ceramic ring or segment comprises at least one capacitive structure. The ceramic housing comprises a fourth ceramic ring or segment located between the middle shield and the second contact end cap. A capacitive structure of the third ceramic ring or segment comprises that a first end face of the third ceramic ring or segment is metalized and electrically connected to the middle shield. A capacitive structure of the third ceramic ring or segment comprises that a second end face of the third ceramic ring or segment is metalized and electrically connected to a first end face of the fourth ceramic ring or segment. Thus, the third ceramic ring or segment acts in effect as a parallel plate capacitor, having metalized ends.

In an example, the fourth ceramic ring or segment comprises at least one capacitive structure. A capacitive structure of the fourth ceramic ring or segment comprises that a second end face of the fourth ceramic ring or segment opposite to the first end face of the fourth ceramic ring or segment is metalized and electrically connected to the second contact end cap. Thus, the third ceramic ring or segment and the fourth ceramic ring or segment act in effect as parallel plate capacitors in series, having metalized ends.

In an example, the first contact is a movable contact (SK) and the second contact is a fixed contact (FK).

In an example, the vacuum interrupter comprises at least one ceramic ring or segment, wherein each of the at least one ceramic ring or segment comprises at least one capacitive structure; and wherein one or more ceramic rings or segments of the at least one ceramic ring or segment is located between the middle shield and the first contact end cap and/or wherein one or more ceramic rings or segments of the at least one ceramic ring or segment is located between the middle shield and the second contact end cap (in case on shield on floating potential is there).

In an example, a ceramic ring or segment of the one or more ceramic rings or segments located between the middle shield and the first contact end cap is located external to the ceramic housing, and wherein a capacitive structure of the ceramic ring or segment comprises at least one metalized cylindrical surface.

Located external to the ceramic housing means located outside of the ceramic housing, in that the ceramic housing is spaced a first radial distance from a center axis of the vacuum interrupter and the ceramic ring or segment located external to the ceramic housing is then located such that it is spaced a second radial distance from the center axis of the vacuum interrupter that is greater than the first radial distance.

In an example, wherein the least one metalized cylindrical surface of the ceramic ring or segment located external to the ceramic housing comprises an inward facing surface.

In an example, the inward facing surface is within a groove in the ceramic ring or segment.

In an example, the at least one metalized cylindrical surface of the ceramic ring or segment located external to the ceramic housing comprises an outward facing surface.

In an example, the outward facing surface is within a groove in the ceramic ring or segment located external to the ceramic housing.

In an example, a first end face of the ceramic ring or segment located external to the ceramic housing is metalized and electrically connected to the middle shield and a second end face of the ceramic ring or segment located external to the ceramic housing opposite to the first end face is metalized and electrically connected to the first contact end cap.

In an example, a capacitive structure is formed between the at least one metalized cylindrical surface of the ceramic ring or segment located external to the ceramic housing and the first end face of the ceramic ring or segment located external to the ceramic housing.

In an example, a capacitive structure is formed between the at least one metalized cylindrical surface of the ceramic ring or segment located external to the ceramic housing and the second end face of the ceramic ring or segment located external to the ceramic housing.

In an example, a capacitive structure comprises at least one further metalized cylindrical surface of the ceramic ring or segment located external to the ceramic housing.

In an example, the least one further metalized cylindrical surface of the ceramic ring or segment located external to the ceramic housing comprises an inward facing surface.

In an example, the inward facing surface is within a further groove in the ceramic ring or segment located external to the ceramic housing.

In an example, the at least one further metalized cylindrical surface of the ceramic ring or segment located external to the ceramic housing comprises an outward facing surface.

In an example, the outward facing surface is within a further groove in the ceramic ring or segment located external to the ceramic housing.

In an example, a further capacitive structure is formed between the at least one metalized cylindrical surface of the ceramic ring or segment located external to the ceramic housing and the at least one further metalized cylindrical surface of the first ceramic ring or segment.

In an example, a capacitive structure is formed between the at least one further metalized cylindrical surface of the ceramic ring or segment located external to the ceramic housing and the second end face of the first ceramic ring or segment. Thus, an externally located ceramic ring or segment located between the middle shield and the first contact end cap acts as one or more capacitors, where one or more capacitors can be formed between a metalized groove in the ceramic ring or segment and a metallized end face of the ceramic ring or segment that is connected to the middle shield, and between metalized grooves themselves, and between a metalized groove in the ceramic ring or segment and a metallized end face of the ceramic ring or segment that is connected to the first contact end cap.

In an example, a ceramic ring or segment of the one or more ceramic rings or segments located between the middle shield and the second contact end cap is located external to the ceramic housing, and wherein the capacitive of the ceramic ring or segment comprises at least one metalized cylindrical surface.

In an example, the least one metalized cylindrical surface of the ceramic ring or segment located external to the ceramic housing and located between the middle shield and the second contact end cap comprises an inward facing surface.

In an example, the inward facing surface is within a groove in the ceramic ring or segment located external to the ceramic housing and located between the middle shield and the second contact end cap.

In an example, the least one metalized cylindrical surface of the ceramic ring or segment located external to the ceramic housing and located between the middle shield and the second contact end cap comprises an outward facing surface.

In an example, the outward facing surface is within a groove in the ceramic ring or segment located external to the ceramic housing and located between the middle shield and the second contact end cap.

In an example, a first end face of the ceramic ring or segment located external to the ceramic housing and located between the middle shield and the second contact end cap is electrically connected to the middle shield and a second end face of the ceramic ring or segment located external to the ceramic housing and located between the middle shield and the second contact end cap opposite to the first end face is electrically connected to the second contact end cap.

In an example, a capacitive structure is formed between the at least one metalized cylindrical surface of the ceramic ring or segment located external to the ceramic housing and located between the middle shield and the second contact end cap and the first end face of the ceramic ring or segment located external to the ceramic housing and located between the middle shield and the second contact end cap.

In an example, a capacitive structure is formed between the at least one metalized cylindrical surface of the ceramic ring or segment located external to the ceramic housing and located between the middle shield and the second contact end cap and the second end face of the ceramic ring or segment located external to the ceramic housing and located between the middle shield and the second contact end cap. Thus, in case of a multi shield arrangement are in between the selected shield these ceramic rings or segments are located.

In an example, a capacitive structure comprises at least one further metalized cylindrical surface of the ceramic ring or segment located external to the ceramic housing and located between the middle shield and the second contact end cap.

In an example, the least one further metalized cylindrical surface of the ceramic ring or segment located external to the ceramic housing and located between the middle shield and the second contact end cap comprises an inward facing surface.

In an example, the inward facing surface is within a further groove in the ceramic ring or segment located external to the ceramic housing and located between the middle shield and the second contact end cap.

In an example, the at least one further metalized cylindrical surface of the ceramic ring or segment located external to the ceramic housing and located between the middle shield and the second contact end cap comprises an outward facing surface.

In an example, the outward facing surface is within a further groove in the ceramic ring or segment located external to the ceramic housing and located between the middle shield and the second contact end cap.

In an example, a further capacitive structure is formed between the at least one metalized cylindrical surface of the ceramic ring or segment located external to the ceramic housing and located between the middle shield and the second contact end cap and the at least one further metalized cylindrical surface of the ceramic ring or segment located external to the ceramic housing and located between the middle shield and the second contact end cap.

In an example, a further capacitive structure is formed between the at least one further metalized cylindrical surface of the ceramic ring or segment located external to the ceramic housing and located between the middle shield and the second contact end cap and the second end face of the ceramic ring or segment located external to the ceramic housing and located between the middle shield and the second contact end cap. Thus, an externally located ceramic ring or segment located between the middle shield and the second contact end cap acts as one or more capacitors, where one or more capacitors can be formed between a metalized groove in the ceramic ring or segment and a metallized end face of the ceramic ring or segment that is connected to the middle shield, and between metalized grooves themselves, and between a metalized groove in the ceramic ring or segment and a metallized end face of the ceramic ring or segment that is connected to the second contact end cap.

In an example, a ceramic ring or segment of the one or more ceramic rings or segments located between the middle shield and the first contact end cap is located internal to the ceramic housing. A capacitive structure of the ceramic ring or segment comprises that a first end face of the first ceramic ring or segment is metalized and electrically connected to the middle shield.

Located internal to the ceramic housing means located inside of the ceramic housing, in that the ceramic housing is spaced the first radial distance from the center axis of the vacuum interrupter and the ceramic ring or segment located internal to the ceramic housing is then located such that it is spaced a third radial distance from the center axis of the vacuum interrupter that is less than the first radial distance.

In an example, a capacitive structure of the ceramic ring or segment located internal to the ceramic housing comprises that a second end face of the ceramic ring or segment opposite to the first end face of the ceramic ring or segment is metalized and electrically connected to the first contact end cap. Thus, the internal ceramic ring or segment in effect acts as a parallel plate capacitor with metalized ends.

In an example, a further ceramic ring or segment of the one or more ceramic rings or segments located between the middle shield and the first contact end cap is located internal to the ceramic housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the first contact end cap.

In case of a Multi-shield arrangement the ceramic ring or segment can be added in between all or partly on shields. In addition, the inner shield structure can be fixed on the inner capacitor rings or segments, the outer ceramic can be selected as one part or at least two parts. The shield is fixed on the inner ceramic ring or segment structure, maybe a vacuum interrupter with one shielding or even with several of those. The outer ceramic insulator ring or segment can be one part from fixed to movable side, or also at least made of two single cylinder parts. Thus, the internal ceramic rings or segments in effect act as parallel plate capacitors in series with metalized ends.

In an example, a ceramic ring or segment of the one or more ceramic rings or segments located between the middle shield (or in between all shielding in case of Multi-shield design) and the second contact end cap is located internal to the ceramic housing, and a capacitive structure of the ceramic ring or segment comprises that a first end face of the ceramic ring or segment is metalized and electrically connected to the middle shield (or to all which are located and on floating potential).

In an example, a capacitive structure of the ceramic ring or segment located internal to the ceramic housing and located between the middle shield and the second contact end cap comprises that a second end face of the ceramic ring or segment opposite to the first end face of the ceramic ring or segment is metalized and electrically connected to the second contact end cap. Thus, the internal ceramic ring or segment in effect acts as a parallel plate capacitor with metalized ends.

In an example, a further ceramic ring or segment of the one or more ceramic rings or segments located between the middle shield and the second contact end cap is located internal to the ceramic housing. A capacitive structure of the further ceramic ring or segment comprises that a first end face of the further ceramic ring or segment is metalized and electrically connected to a second end face of the ceramic ring or segment opposite to the first end face of the ceramic ring or segment. A capacitive structure of the further ceramic ring or segment comprises that a second end face of the further ceramic ring or segment opposite to the first end face of the further ceramic ring or segment is metalized and electrically connected to the second contact end cap. Thus, the internal ceramic rings or segments in effect act as parallel plate capacitors in series with metalized ends.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A vacuum interrupter, comprising:
a first contact;
a second contact;
a middle shield;
a first contact end cap;
a second contact end cap;
a ceramic housing; and
at least one ceramic ring or segment;
wherein the first contact is configured to be held at a first potential when the first contact and the second contact are separated from one another;
wherein the second contact is configured to be held at a second potential when the first contact and the second contact are separated from one another;
wherein the first contact end cap is configured to be held at the first potential when the first contact and the second contact are separated from one another;
wherein the second contact end cap is configured to be held at the second potential when the first contact and the second contact are separated from one another;
wherein the middle shield is configured to be held at floating potential;
wherein the middle shield is located around a region between the first contact and the second contact;
wherein the ceramic housing is located between the first contact end cap and the second contact end cap;
wherein each of the at least one ceramic ring or segment comprises at least one capacitive structure; and
wherein one or more ceramic rings or segments of the at least one ceramic ring or segment is located between the middle shield and the first contact end cap and/or wherein one or more ceramic rings or segments of the at least one ceramic ring or segment is located between the middle shield and the second contact end cap.

2. The vacuum interrupter according to claim 1, wherein a ceramic ring or segment of the one or more ceramic rings or segments located between the middle shield and the first contact end cap is located external to the ceramic housing, and wherein a capacitive structure of the ceramic ring or segment comprises at least one metalized cylindrical surface.

3. The vacuum interrupter according to claim 2, wherein the at least one metalized cylindrical surface of the ceramic ring or segment located external to the ceramic housing comprises an outward facing surface.

4. The vacuum interrupter according to claim 3, wherein the outward facing surface is within a groove in the ceramic ring or segment located external to the ceramic housing.

5. The vacuum interrupter according to claim 2, wherein a first end face of the ceramic ring or segment located external to the ceramic housing is metalized and electrically connected to the middle shield and a second end face of the ceramic ring or segment located external to the ceramic housing opposite to the first end face is metalized and electrically connected to the first contact end cap.

6. The vacuum interrupter according to claim 1, wherein a ceramic ring or segment of the one or more ceramic rings or segment located between the middle shield and the second contact end cap is located external to the ceramic housing, and wherein a capacitive of the ceramic ring or segment comprises at least one metalized cylindrical surface.

7. The vacuum interrupter according to claim 1, wherein a ceramic ring or segment of the one or more ceramic rings or segments located between the middle shield and the first contact end cap is located internal to the ceramic housing, and wherein a capacitive structure of the ceramic ring or segment comprises that a first end face of the first ceramic ring or segment is metalized and electrically connected to the middle shield.

8. The vacuum interrupter according to claim 7, wherein a capacitive structure of the ceramic ring or segment located internal to the ceramic housing comprises that a second end face of the ceramic ring or segment opposite to the first end face of the ceramic ring or segment is metalized and electrically connected to the first contact end cap.

9. The vacuum interrupter according to claim 7, wherein a further ceramic ring or segment of the one or more ceramic rings or segments located between the middle shield and the first contact end cap is located internal to the ceramic housing, wherein a capacitive structure of the further ceramic ring or segment comprises that a first end face of the further ceramic ring or segment is metalized and electrically connected to a second end face of the ceramic ring or segment opposite to the first end face of the ceramic ring or segment , and wherein a capacitive structure of the further ceramic ring or segment comprises that a second end face of the further ceramic ring or segment opposite to the first end face of the further ceramic ring or segment is metalized and electrically connected to the first contact end cap.

10. The vacuum interrupter according to claim 1, wherein a ceramic ring or segment of the one or more ceramic rings or segments located between the middle shield and the second contact end cap is located internal to the ceramic housing, and wherein a capacitive structure of the ceramic ring or segment comprises that a first end face of the ceramic ring or segment is metalized and electrically connected to the middle shield.

11. The vacuum interrupter according to claim 10, wherein a capacitive structure of the ceramic ring or segment located internal to the ceramic housing and located between the middle shield and the second contact end cap comprises that a second end face of the ceramic ring or segment opposite to the first end face of the ceramic ring or segment is metalized and electrically connected to the second contact end cap.

12. The vacuum interrupter according to claim 9, wherein a further ceramic ring or segment of the one or more ceramic rings or segments located between the middle shield and the second contact end cap is located internal to the ceramic housing, wherein a capacitive structure of the further ceramic ring or segment comprises that a first end face of the further ceramic ring or segment is metalized and electrically connected to a second end face of the ceramic ring or segment opposite to the first end face of the ceramic ring or segment , and wherein a capacitive structure of the further ceramic ring comprises that a second end face of the further ceramic ring or segment opposite to the first end face of the further ceramic ring or segment is metalized and electrically connected to the second contact end cap.

13. The vacuum interrupter according to claim 12, wherein a further ceramic ring or segment of the one or more ceramic rings or segments located between the middle shield and the contact end cap is located internal to the ceramic housing or as the external housing, wherein a capacitive structure of the further ceramic ring or segment comprises that a first end face of the further ceramic ring or segment is metalized and electrically connected to a second end face of the ceramic ring or segment opposite to the first end face of the ceramic ring or segment, and wherein a capacitive structure of the further ceramic ring or segment comprises that a second end face of the further ceramic ring or segment opposite to the first end face of the further ceramic ring or segment is metalized and electrically connected to the second contact end cap at the both end cap or the vacuum interrupter.

14. A vacuum interrupter, comprising:
a first contact;
a second contact;
a middle shield;
a first contact end cap;
a second contact end cap; and
a ceramic housing;
wherein the first contact is configured to be held at a first potential when the first contact and the second contact are separated from one another;
wherein the second contact is configured to be held at a second potential when the first contact and the second contact are separated from one another;
wherein the first contact end cap is configured to be held at the first potential when the first contact and the second contact are separated from one another;
wherein the second contact end cap is configured to be held at the second potential when the first contact and the second contact are separated from one another;
wherein the middle shield is configured to be held at floating potential;
wherein the middle shield is located around a region between the first contact and the second contact;
wherein the ceramic housing is located between the first contact end cap and the second contact end cap;
wherein the ceramic housing comprises a first ceramic ring or segment located between the middle shield and the first contact end cap, wherein the first ceramic ring or segment comprises at least one capacitive structure, and the ceramic housing comprises a second ceramic ring or segment located between the middle shield and the first contact end cap; and
wherein a capacitive structure of the first ceramic ring or segment comprises a first end face of the first ceramic ring or segment that is metalized and electrically connected to the middle shield, wherein a capacitive structure of the first ceramic ring or segment comprises that a second end face of the first ceramic ring or segment is metalized and electrically connected to a first end face of the second ceramic ring or segment.

15. The vacuum interrupter according to claim 14, wherein the second ceramic ring or segment comprises at least one capacitive structure, wherein a capacitive structure of the second ceramic ring or segment comprises that a second end face of the second ceramic ring or segment opposite to the first end face of the second ceramic ring or segment is metalized and electrically connected to the first contact end cap.

16. The vacuum interrupter according to claim 14, wherein the ceramic housing comprises a third ceramic ring or segment located between the middle shield and the second contact end cap, wherein the third ceramic ring or segment comprises at least one capacitive structure, and the ceramic housing comprises a fourth ceramic ring or segment located between the middle shield and the second contact end cap; and wherein a capacitive structure of the third ceramic ring or segment comprises that a first end face of the third ceramic ring or segment is metalized and electrically connected to the middle shield, wherein a capacitive structure of the third ceramic ring or segment comprises that a second end face of the third ceramic ring or segment is metalized and electrically connected to a first end face of the fourth ceramic ring or segment.

17. The vacuum interrupter according to claim 16, wherein the fourth ceramic ring or segment comprises at least one capacitive structure, wherein a capacitive structure of the fourth ceramic ring or segment comprises that a second end face of the fourth ceramic ring or segment opposite to the first end face of the fourth ceramic ring or segment is metalized and electrically connected to the second contact end cap.
